(19) United States
(12) Patent Application Publication
(10) Pub. No.: US 2015/0242360 A1
(43) Pub. Date: Aug. 27, 2015

(54) NUMERICAL SCALING METHOD FOR MATHEMATICAL PROGRAMS WITH QUADRATIC OBJECTIVES AND/OR QUADRATIC CONSTRAINTS

(71) Applicant: International Business Machines Corporation, Armonk, NY (US)

(72) Inventors: Irvin Jay Lustig, Short Hills, NJ (US); Helmut Mausser, Toronto (CA); Oleksandr Romanko, Toronto (CA)

(73) Assignee: International Business Machines Corporation, Armonk, NY (US)

(21) Appl. No.: 14/189,976

(22) Filed: Feb. 25, 2014

(51) Int. Cl. G06F 17/10

(52) U.S. Cl. CPC G06F 17/10

(57) ABSTRACT

A method for a quadratic program or quadratically constrained program stored in a non-transitory computer readable medium, includes receiving input for coefficients of a quadratic problem or a quadratically constrained problem by a computer for storage in the non-transitory computer readable medium, determining scaling factors by a processor by using the input in the quadratic program or quadratically constrained program configured for optimality conditions by considering a symmetric N×N matrix Q⁰ and/or M_{q} N×N matrices Q^{k} in the transformation, where N is an integer and k=1, . . . , M_{q} is an integer, and outputting, by the computer, transformed coefficients of column scaling factor β, row scaling factor α, and right hand side scaling factor γ, where β>0, α>0 and γ>0.

### BACKGROUND OF THE INVENTION

1. Field of the Invention

The disclosed invention relates generally to the solution of mathematical programs on a computer, and more particularly, but not by way of limitation, relating to a numerical scaling method for mathematical programs with quadratic objectives and/or quadratic constraints in a computer, a computing device, computer networks and/or other computer type systems.

2. Description of the Related Art

When mathematical programs are solved on a computer using any algorithm, the computer uses floating point computation to execute the algorithm. Floating point computation is done with a fixed number of significant digits in any computation (addition, subtraction, multiplication, division).

Generally, a floating point is a method representing a numerical value that contains a decimal point, i.e., not necessarily a whole number. In a computer, a calculation takes into account the varying location of the decimal point (if base 10) or binary point (if base 2). For example, floating point numbers are numbers that contain floating decimal points. For example, the numbers 1.8, 7×10⁻⁴, and −5.1234 are floating point numbers. The sign, magnitude and exponent of each number are specified separately.

Computers recognize real numbers that contain fractions as floating point numbers. Since a computer's memory is limited, the computer cannot store numbers with infinite precision. At some point, there has to be a cut off or round-off of the value.

A floating point number will have two parts. A significand contains the number's digits. Negative significands represent negative numbers. An exponent says where the decimal (or binary) point is placed relative to the beginning of the significand. Negative exponents are used to represent numbers that are very small (i.e. close to zero), while positive exponents are used to represent numbers that are very large.

Most hardware and programming languages use floating-point numbers in the same binary formats, which are defined in the IEEE 754 standard. The usual formats can be, for example, 32 or 64 bits in total length. The IEEE 754 standard includes rules for rounding when doing arithmetic computations.

As a result, in computers or computing devices, algorithms based on these fundamental operations are subject to round-off error, limiting the accuracy of the algorithms, and potentially making the implementation of those algorithms on the computer numerically unstable. A round-off error is the difference between the exact value and the approximation.

For example, consider using on a computer a really large number, such as a trillion (1,000,000,000,000) dollars with 12 zeros and adding to it one-trillionth (1/1,000,000,000,000) of a dollar (unit for currency). Therefore, if you add on a computer, the answer in a computer would be a trillion (1,000,000,000,000) dollars because the computer has a limited number of digits that it uses in a computation. Therefore, effectively, it will internally round off the answer. Therefore, whenever you apply an algorithm on a computer, one has to worry about whether the algorithm is approximated on the computer.

Therefore, when more complex algorithms are used, the effect of the round-off error in the above example of simple addition of large and small numbers is magnified exponentially.

To improve the accuracy of the computations and the overall stability of the implementation of the solving algorithm, the input data of a mathematical program can be numerically scaled so that an equivalent problem is created for computation on the computer, with the goal being to reduce the severity of the round-off error present in the computation.

For example, consider computing the purchase cost as the number of units bought times the price per unit. Suppose product A costs one trillion dollars per unit while product B costs one-millionth of a dollar per unit. When computing the total cost of purchasing products A and B on a computer, the calculations are more accurate if the quantity of A is expressed in trillionths of units, each costing one dollar, and the quantity of B is expressed in millions of units, each costing one dollar. Effectively, numerical scaling makes the numbers more manageable in a computational sense and reduces the round-off error.

Linear programs (LP) are also plagued with large round-off errors, which can be very costly in the business world There are numerical scaling methods for linear programs based on some well known algorithms.

There have been a plurality of problems in conventional computer systems in that it is very difficult to solve quadratic problems accurately and in a timely manner. The present systems have a problem in that they are either not accurate or take too long to compute.

There is a need for a way for a computer system to solve quadratic problems in an easier fashion, more efficiently, and with a greater degree of accuracy.

Therefore, it is also desirable to provide an improved way to numerically scale mathematic computations on the computer. There is a need to improve the accuracy of the computations and the overall stability of the implementation of the solving algorithm, with the goal being to reduce the severity of the round-off error present in the computation, especially in mathematical programs with quadratic objectives and/or quadratic constraints.

### SUMMARY OF INVENTION

In view of the foregoing and other problems, disadvantages, and drawbacks of the aforementioned background art, an exemplary aspect of the disclosed invention provides a numerical scaling method for mathematical programs with quadratic objectives and/or quadratic constraints.

An exemplary aspect of the disclosed invention is to provide a method for a quadratic program or quadratically constrained program stored in a non-transitory computer readable medium, the method including receiving input for coefficients of a quadratic problem or a quadratically constrained problem by a computer for storage in the non-transitory computer readable medium, determining scaling factors by a processor by using the input in the quadratic program or quadratically constrained program configured for optimality conditions by considering symmetric N×N matrices Q⁰ and Q^{k} in the transformation, where N is an integer, k are integers 1, 2, through M_{q}, M_{q} is an integer representing the number of matrices, and outputting, by the computer, transformed coefficients of column scaling factor β, row scaling factor α, and right hand side scaling factor γ, where β>0, α>0 and γ>0.

The receiving further includes receiving input for coefficients A, b, c, and Q⁰ by the computer for storage in the non-transitory computer readable medium, the determining further comprises scaling factors by a processor in the computer by using the input in a quadratic program:

$${min}_{x} {c}^{T} x + \frac{1}{2} {x}^{T} {Q}^{0} x$$

$$s . t . \\ Ax = b$$

$$x \geq 0$$

where c is a cost vector of size N, b is a vector of right hand side variables of size M, and Q⁰ is a symmetric N×N matrix, A is an M×N matrix, where N and M are integers, x is a vector of N variables, wherein a transformation for the scaling factors provides for the quadratic programs as follows:

$$min {\tilde{c}}^{T} \tilde{x} + \frac{1}{2} {\tilde{x}}^{T} {\tilde{Q}}^{0} \tilde{x}$$

$$s . t . \\ \tilde{A} \tilde{x} = \tilde{b}$$

$$\tilde{x} \geq 0$$

$${\tilde{c}}_{j} = {α}_{0} {β}_{j} {c}_{j}$$

$${\tilde{Q}}_{ij}^{0} = \frac{{α}_{0} {β}_{i} {β}_{j}}{γ} {Q}_{ij}^{0}$$

$${\tilde{A}}_{ij} = {α}_{i} {β}_{j} {A}_{ij}$$

$${\tilde{b}}_{i} = {α}_{i} γ {b}_{i} .$$

The receiving further includes receiving input for coefficients A, b, c, Q⁰, h^{k}, d^{k} and Q^{k} by the computer for storage in the non-transitory computer readable medium, the determining further comprises scaling factors by a processor in the computer by using the input in a quadratically constrained program:

$${min}_{x} {c}^{T} x + \frac{1}{2} {x}^{T} {Q}^{0} x$$

$$s . t . \\ {( {d}^{k} )}^{T} x + {x}^{T} {Q}^{k} x \leq {h}^{k} , k = 1 , 2 , … , {M}_{q}$$

$$Ax = b$$

$$x \geq 0$$

where c is a cost vector of size N, b is a vector of right hand side variables of size M, and Q⁰ and Q^{k} are symmetric N×N matrices, M_{q} is an integer, k is an integer indexing the matrices Q^{k}, A is an M×N matrix, where N and M are integers, d^{k} is a set of M_{q} vectors of size N, and h^{k} is a set of M_{q} numbers, x is a vector of N variables, wherein a transformation for the scaling factors provides for the quadratically constrained programs as follows:

$$min {\tilde{c}}^{T} \tilde{x} + \frac{1}{2} {\tilde{x}}^{T} {\tilde{Q}}^{0} \tilde{x}$$

$$s . t . \\ {( {\tilde{d}}^{k} )}^{T} \tilde{x} + {\tilde{x}}^{T} {\tilde{Q}}^{k} \tilde{x} \leq {\tilde{h}}^{k} , k = 1 , … , {M}_{q}$$

$$\tilde{A} \tilde{x} = \tilde{b}$$

$$\tilde{x} \geq 0$$

$${\tilde{d}}_{j}^{k} = {α}_{M + k} {β}_{j} {d}_{j}^{k}$$

$${\tilde{Q}}_{ij}^{k} = \frac{{α}_{M + k} {β}_{i} {β}_{j}}{γ} {Q}_{ij}^{k} \\ {\tilde{h}}^{k} = {α}_{M + k} γ {h}^{k} \\ {\tilde{c}}_{j} = {α}_{0} {β}_{j} {c}_{j} .$$

The inputs of coefficients A, b, c, Q⁰, Q^{k}, d^{k}, h^{k} are received by the computer for storage on the non-transitory computer readable medium for the quadratically constrained programs, the inputs of coefficients being real numbers. The optimality conditions comprise Karush-Kuhn-Tucker conditions for quadratic programming.

Moreover, the outputs can be sent to a solver program for mathematical computation in the computer. In addition the determining of scaling factors further includes determining column scaling factors β by using a scaling function. The determining of scaling factors can further include, after determining the column scaling factor, determining row scaling factors α by using the scaling function. The determining of scaling factors can further include determining the right hand side scaling factor γ. The determining of scaling factors can further include setting an initial row scaling factor of α₀ for a quadratic objective function.

Another exemplary aspect of the disclosed invention is to provide a method for a quadratic program or quadratically constrained program stored in a non-transitory computer readable medium for execution by a processor of a computer, the method includes receiving input for coefficients of a quadratic problem or a quadratically constrained problem by a computer for storage in the non-transitory computer readable medium, determining scaling factors by a processor by using the input in the quadratic program or quadratically constrained program configured for optimality conditions by considering a symmetric N×N matrix Q⁰ in the transformation, where N is an integer number, wherein the scaling factors comprise transformed coefficients of column scaling factor β, row scaling factor α, and right hand side scaling factor γ, where β>0, α>0 and γ>0.

The receiving further includes receiving input for coefficients A, b, c, and Q⁰ by the computer for storage in the non-transitory computer readable medium, the determining further comprises scaling factors by a processor in the computer by using the input in a quadratic program:

$${min}_{x} {c}^{T} x + \frac{1}{2} {x}^{T} {Q}^{0} x$$

$$s . t . \\ Ax = b$$

$$x \geq 0$$

where c is a cost vector of size N, b is a vector of right hand side variables of size M, and Q⁰ is a symmetric N×N matrix, A is an M×N matrix, where N and M are integers, x is a vector of N variables, wherein a transformation for the scaling factors provides for the quadratic programs as follows:

$$min {\tilde{c}}^{T} \tilde{x} + \frac{1}{2} {\tilde{x}}^{T} {\tilde{Q}}^{0} \tilde{x}$$

$$s . t . \\ \tilde{A} \tilde{x} = \tilde{b}$$

$$\tilde{x} \geq 0$$

$${\tilde{c}}_{j} = {α}_{0} {β}_{j} {c}_{j}$$

$${\tilde{Q}}_{ij}^{0} = \frac{{α}_{0} {β}_{i} {β}_{j}}{γ} {Q}_{ij}^{0}$$

$${\tilde{A}}_{ij} = {α}_{i} {β}_{j} {A}_{ij}$$

$${\tilde{b}}_{i} = {α}_{i} γ {b}_{i} .$$

The receiving further includes receiving input for coefficients A, b, c, Q⁰, h^{k}, d^{k} and Q^{k} by the computer for storage in the non-transitory computer readable medium, the determining further comprises scaling factors by a processor in the computer by using the input in a quadratically constrained program:

$${min}_{x} {c}^{T} x + \frac{1}{2} {x}^{T} {Q}^{0} x$$

$$s . t . \\ {( {d}^{k} )}^{T} x + {x}^{T} {Q}^{k} x \leq {h}^{k} , k = 1 , 2 , … , {M}_{q}$$

$$Ax = b$$

$$x \geq 0$$

where c is a cost vector of size N, b is a vector of right hand side variables of size M, and Q⁰ and Q^{k} are symmetric N×N matrices, M_{q} is an integer, k is an integer indexing the matrices Q^{k}, A is an M×N matrix, where N and M are integers, d^{k} is a set of M_{q} vectors of size N, and h^{k} is a set of M_{q} numbers, x is a vector of N variables, wherein a transformation for the scaling factors provides for the quadratically constrained programs as follows:

$$min {\tilde{c}}^{T} \tilde{x} + \frac{1}{2} {\tilde{x}}^{T} {\tilde{Q}}^{0} \tilde{x}$$

$$s . t . \\ {( {\tilde{d}}^{k} )}^{T} \tilde{x} + {\tilde{x}}^{T} {\tilde{Q}}^{k} \tilde{x} \leq {\tilde{h}}^{k} , k = 1 , … , {M}_{q}$$

$$\tilde{A} \tilde{x} = \tilde{b}$$

$$\tilde{x} \geq 0$$

$${\tilde{d}}_{j}^{k} = {α}_{M + k} {β}_{j} {d}_{j}^{k}$$

$${\tilde{Q}}_{ij}^{k} = \frac{{α}_{M + k} {β}_{i} {β}_{j}}{γ} {Q}_{ij}^{k} \\ {\tilde{h}}^{k} = {α}_{M + k} γ {h}^{k} \\ {\tilde{c}}_{j} = {α}_{0} {β}_{j} {c}_{j} .$$

The inputs of coefficients A, b, c, Q⁰, Q^{k}, d^{k}, h^{k} are received by the computer for storage on the non-transitory computer readable medium for the quadratically constrained programs, the inputs of coefficients being real numbers. The optimality conditions comprise Karush-Kuhn-Tucker conditions for quadratic programming.

Moreover, there can be a sending of the outputs of the numerical scaling procedure to a solver program for mathematical computation in the computer. In addition there the determining of scaling factors further includes determining column scaling factors β by using a scaling function. The determining of scaling factors can further include, after determining the column scaling factor, determining row scaling factors α by using the scaling function. The determining of scaling factors can further include determining the right hand side scaling factor γ. The determining of scaling factors can further include setting an initial row scaling factor of α₀ for a quadratic objective function.

In another exemplary aspect of the invention, there is a computer for a quadratic program and quadratically constrained program, the computer includes a non-transitory computer readable memory storing input for coefficients of the quadratic problem or the quadratically constrained problem, a processor determining scaling factors by using the input in the quadratic program or the quadratically constrained program configured for optimality conditions by considering a symmetric N×N matrix Q⁰ in the transformation, where N is an integer, and an output section outputting transformed coefficients of column scaling factor β, row scaling factor α, and right hand side scaling factor γ, where β>0, α>0 and γ>0.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF DRAWINGS

The exemplary aspects of the invention will be better understood from the following detailed description of the exemplary embodiments of the invention with reference to the drawings.

FIG. 1 shows a high level flow chart regarding a conventional linear programming numerical scaling method.

FIG. 2 shows a high level flow chart of a quadratic program (QP) numerical scaling method of an exemplary embodiment of the invention.

FIG. 3 shows a high level flow chart of a quadratically constrained program (QCP) numerical scaling method of an exemplary embodiment of the invention.

FIG. 4 illustrates a Karush-Kuhn-Tucker (KKT) system for the transformed quadratic program (QP) of an exemplary embodiment of the invention.

FIG. 5 illustrates a detailed method of an exemplary embodiment of the invention.

FIG. 6 illustrates an exemplary hardware/information handling system for incorporating the exemplary embodiment of the invention therein.

FIG. 7 illustrates a non-transitory signal-bearing storage medium for storing machine-readable instructions of a program that implements the method according to the exemplary embodiment of the invention.

### DETAILED DESCRIPTION OF A PREFERRED EMBODIMENT

The invention will now be described with reference to the drawing figures, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

The exemplary disclosure describes, at least in part but not limited to, a numerical scaling method for mathematical programs with quadratic objectives and/or quadratic constraints.

To improve the accuracy of the computations and the overall stability of the implementation of the solving method, the input data of a mathematical program can be numerically scaled so that an equivalent problem is created for computation on the computer, with the goal being to reduce the severity of the round-off error present in the computation.

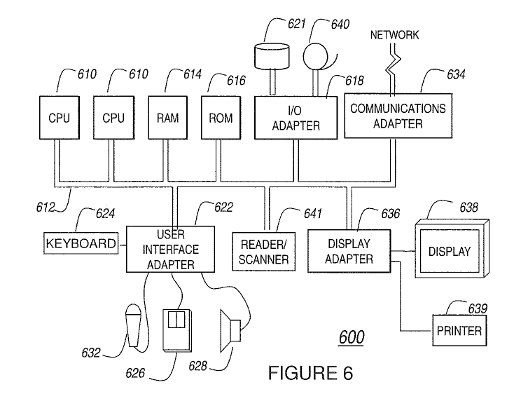

In this application, the term “Numerical Scaling” refers to, for example, the process of taking the input data and computing scale factors that are then applied to the original problem in order to make the problem easier to solve on a computer 600 (FIG. 6). The problems being solved are quadratic programs and quadratically constrained programs.

### Numerical Scaling for Linear Programs

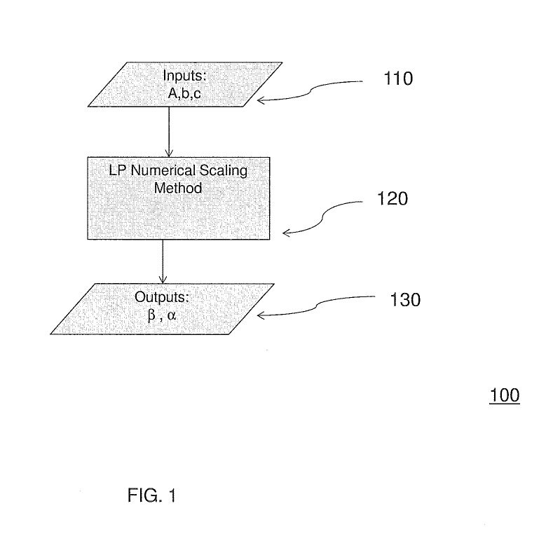

As mentioned above, previous methods were applied to linear programs. FIG. 1 shows a high level flow chart regarding a linear programming numerical scaling method 100.

Numerical scaling methods for linear programs (LP) are described as the following:

$${min}_{x} {c}^{T} x \\ s . t . \\ Ax = b \\ x \geq 0 \qquad ( 1.1 )$$

The methods for linear programming use the values of (c, A, b) as they are presented to the computer 600 (FIG. 6) for input 110 to create as output 130 variable scales βⱼ, j=1, . . . , N and constraint scales αᵢ, i=1, . . . , M to create an equivalent linear program 120 (FIG. 1):

$${min}_{\tilde{x}} {\tilde{c}}^{T} \tilde{x} \\ s . t . \\ \tilde{A} \tilde{x} = \tilde{b} \\ \tilde{x} \geq 0 \\ {\tilde{c}}_{j} = {β}_{j} {c}_{j} , {\tilde{A}}_{ij} = {α}_{i} {β}_{j} {A}_{ij} , {\tilde{b}}_{i} = {α}_{i} {b}_{i} \qquad ( 1.2 )$$

The goal of computing the vectors β and α is to make the problem as represented in the computer 600 less subject to round-off error when a solving algorithm (such as the algorithms provided in IBM ILOG CPLEX) is executed on the computer 600.

The values β and α are the scales that are respectively applied to the columns and rows of the matrix A (and to the vector c and vector b). The program is linear, but less subject to roundoff errors than without scaling. However, the problems of roundoff errors are still prevalent.

### Numerical Scaling Methods for Quadratic Programs (QP) and Numerical Scaling Methods for Quadratically Constrained Programs (QCP)

Quadratic programs (Q⁰≠0, Q^{k}=0) and quadratically constrained problems (Q^{k}≠0) are discussed in the following.

Numerical scaling methods for quadratic programs (QP) are not described in the literature and are applied to quadratic programs of the form:

$$min {c}^{T} x + \frac{1}{2} {x}^{T} {Q}^{0} x \\ s . t . \\ Ax = b \\ x \geq 0 \qquad ( 2.1 )$$

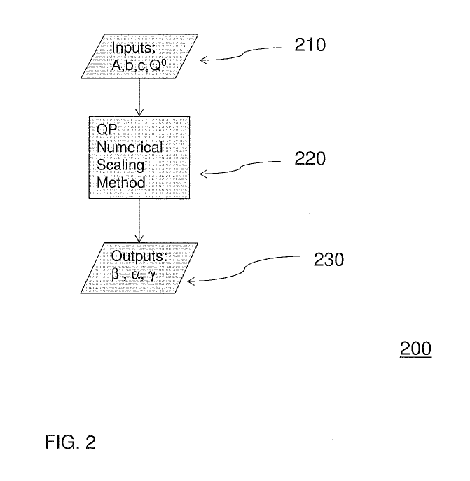

FIG. 2 illustrates a high level flow chart of a quadratic program (QP) scaling method 200 of an exemplary embodiment. Data for coefficients A, b, c, Q⁰ are input 310 into a computer (computer system 600 in FIG. 6) for the quadratic program (2.1).

Numerical scaling methods for quadratically constrained programs (QCP) are also not described in the literature and applied to quadratically constrained programs of the form:

$$min {c}^{T} x + \frac{1}{2} {x}^{T} {Q}^{0} x \\ s . t . \\ {( {d}^{k} )}^{T} x + {x}^{T} {Q}^{k} \leq {h}^{k} , \\ k = 1 , … , {M}_{q} \\ Ax = b \\ x \geq 0 \qquad ( 3.1 )$$

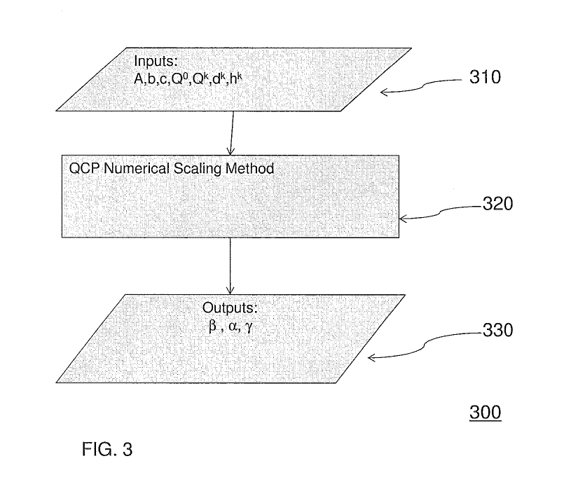

FIG. 3 shows a high level flow chart of a quadratically constrained program (QCP) numerical scaling method 300 of an exemplary embodiment. Data for coefficients A, b, c, Q⁰, Q^{k}, d^{k}, h^{k} are input 310 into a computer (computer system 600 in FIG. 6) for the quadratically constrained program (3.1).

Concerning quadratic programs (QP) and quadratically constrained programs (QCP), if the Q matrices (quadratic matrices) are ignored and then a linear programming numerical scaling algorithm is applied instead to the QP (2.1) or QCP (3.1), the computation maybe easier to deal with, but there would be problems with round-off error.

Stated in more detail, if a method for computing the numerical scales for a linear program is used to compute the vectors β and α, it ignores the presence of the matrix Q⁰ and the matrices Q^{k}. The underlying solving algorithm is likely to have round-off errors in the computation on the computer, because the values in the matrix Q⁰ and matrices Q^{k} were ignored when computing β and α. Moreover, for quadratically constrained problems, the vectors d^{k} and h^{k} are ignored by LP scaling methods.

An exemplary embodiment of invention contributes new methods for numerically scaling quadratic programs, as seen in FIG. 2, and quadratically constrained programs, as seen in FIG. 3, making them easier to solve by solvers such as IBM ILOG CPLEX that would run on the computer system 600 (FIG. 6), improving the numerical stability of the solution algorithms. Numerical scaling involves modifying the coefficients (c, Q⁰, A, b, d^{k}, Q^{k}, h^{k}) 310. Column scales βⱼ, j=1, . . . , N, row scales αᵢ, i=0, 1, . . . , M+M_{q} (objective function corresponds to row 0) and right-hand-side scale rare computed by the method. Therefore, α, β, and γ are outputted in step 230 and 330 from the QP scaling method 220 and the QCP scaling method 320, respectively.

Given a quadratic program (QP) as shown in (2.1), the resulting numerically scaled quadratic program 220 is:

$$min {\tilde{c}}^{T} \tilde{x} + \frac{1}{2} {\tilde{x}}^{T} {\tilde{Q}}^{0} \tilde{x} \\ s . t . \\ \begin{matrix}\tilde{A} \tilde{x} = \tilde{b} & {\tilde{c}}_{j} = {α}_{0} {β}_{j} {c}_{j} \\ x \geq 0 & \end{matrix} \\ {\tilde{Q}}_{ij}^{0} = \frac{{α}_{0} {β}_{i} {β}_{j}}{γ} {Q}_{ij}^{0} {\tilde{A}}_{ij} = {α}_{i} {β}_{j} {A}_{ij} {\tilde{b}}_{i} = {α}_{i} γ {b}_{i} \qquad ( 2.2 )$$

Given a quadratically constrained program (QCP) (3.1), the resulting numerically scaled quadratically constrained program 320 is:

$$min {\tilde{c}}^{T} \tilde{x} + \frac{1}{2} {\tilde{x}}^{T} {\tilde{Q}}^{0} \tilde{x} \\ s . t . \\ {( {\tilde{d}}^{k} )}^{T} \tilde{x} + {\tilde{x}}^{T} {\tilde{Q}}^{k} \tilde{x} \leq {\tilde{h}}^{k} , \\ k = 1 , … , {M}_{q} \\ \tilde{A} \tilde{x} = \tilde{b} \\ \tilde{x} \geq 0 \\ \begin{matrix}{\tilde{d}}_{j}^{k} = {α}_{M + k} {β}_{j} {d}_{j}^{k} & {\tilde{Q}}_{ij}^{k} = \frac{{α}_{M + k} {β}_{i} {β}_{j}}{γ} {Q}_{ij}^{k} \\ {\tilde{h}}^{k} = {α}_{M + k} γ {h}^{k} & {\tilde{c}}_{j} = {α}_{0} {β}_{j} {c}_{j}\end{matrix} \qquad ( 3.2 )$$

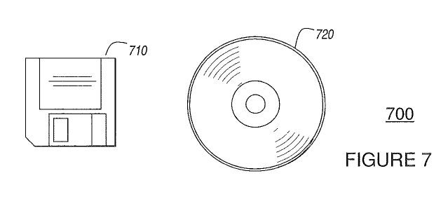

One difference is in the transformation when comparing the quadratic programs of the exemplary embodiments and the conventional linear programs. There is also a value γ that is outputted in the computer 600 from the CPU (central processing unit) 610 executing the programs stored in the memory storage units 700 as seen in FIGS. 6 and 7. Therefore, creating an approximate quadratic program to deal with less than infinite precision in computers helps to reduce the round-off errors. Therefore, the computer system 600 is more accurate because the quadratic problem is qualitatively a better problem that is being solved for. Therefore, the precision of the computer system 600 is improved.

In further detail, one would consider problems with quadratic objectives and/or constraints, e.g.,

$${min}_{x} {c}^{T} x + 1 / 2 {x}^{T} {Q}^{0} x \\ s . t . \\ {( {d}^{k} )}^{T} x + {x}^{T} {Q}^{k} \leq {h}^{k} , \\ k = 1 , … , {M}_{q} \\ Ax = b \\ x \geq 0 , \qquad ( 3.1 as seen above )$$

where x is a vector of N variables, Q⁰ and Q^{k} are symmetric N×N matrices and A is M×N. For example, in financial risk management, x typically represents positions in a set of assets. Instances of the problem 1 arise, for example, when minimizing the variance of a portfolio's return, finding a replicating portfolio that minimizes the squared differences between its cash flows and those of a liability, or placing a constant upper limit on the (squared) tracking error of a portfolio.

Optimization algorithms encounter numerical difficulties when the problem data (c, d^{k}, Q⁰, Q^{k}, h^{k}, A, b) span too many orders of magnitude. In this case, an algorithm may incorrectly conclude that a problem is infeasible or unbounded, or mistakenly report a solution as being optimal. Unfortunately, financial data often vary greatly in size; consider that variances of daily asset returns might be of order 10⁻⁴ or less, while monetary values of portfolios or liability cash flows can exceed 10⁹.

To improve numerical performance, solvers (such as IBM ILOG CPLEX) typically perform some type of scaling to make the problem data similar in magnitude prior to actually solving the problem.

Scaling a problem entails multiplying each of its rows (objective function, constraints) and columns (variables, right-hand side (rhs)) by a positive scaling factor. Thus, when scaling Problem 3.1 one may apply:

N column scaling factors βⱼ>0, j=1, 2, . . . , N;

1+M+M_{q} row scaling factors αᵢ>0, i=0, 1, . . . , M+M_{q} (where i=0 corresponds to the objective function and i=M+k corresponds to the quadratic constraints);

1 rhs scaling factor γ>0.

Observe, for example, that the scaled coefficient of variable xⱼ in the objective function (\tilde{c}ⱼ) is the product of the unsealed coefficient (cⱼ) and the scaling factors for row 0 (α₀) and column j (βⱼ).

In general, a row (column) scaling factor is chosen to make the magnitudes of the coefficients in its associated row (column) closer to one. More precisely, let S={sₙ} be a set of coefficients and let θ=ƒ(S) be a multiplicative scaling factor for S. Define S⁰={n|sₙ≠0} having cardinality N_{S}.

To help solvers such as CPLEX, the transformations provided by the exemplary embodiments (e.g., FIGS. 2-3) would reduce the round-off errors.

Optimality Conditions for QP

An exemplary method of the invention considers the optimality conditions (Karush-Kuhn-Tucker conditions) for quadratic programming.

Below is the original and Cholesky-transformed QP, where Q⁰=LL^{T}

$$\begin{matrix}{min}_{x} {c}^{T} x + \frac{1}{2} {x}^{T} {Q}^{0} x & {min}_{x , y} {c}^{T} x + \frac{1}{2} {y}^{T} y \\ s . t . & s . t . \\ Ax = b & \begin{matrix}{L}^{T} x - y = 0 \\ Ax = b\end{matrix} \\ x \geq 0 & x \geq 0\end{matrix}$$

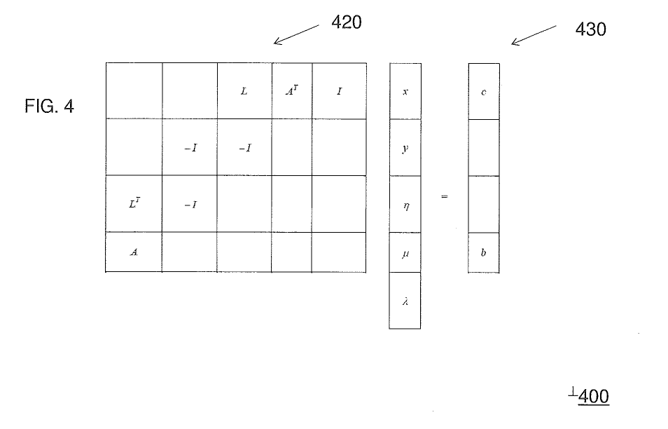

The KKT system (minus complementary slackness) for the transformed QP 400 is shown in FIG. 4.

One would find scaling factors so that the coefficient matrix (L, A) 420 and the right hand side (c, b) 430 of this linear system are well-scaled. Note that Hessian matrix Q⁰ is incorporated into this system through its Cholesky factor, L. As described in the following, one would use \sqrt{Qⱼⱼ^{k}} as a proxy for Lⱼⱼ^{k}, if the Cholesky factorization is not available.

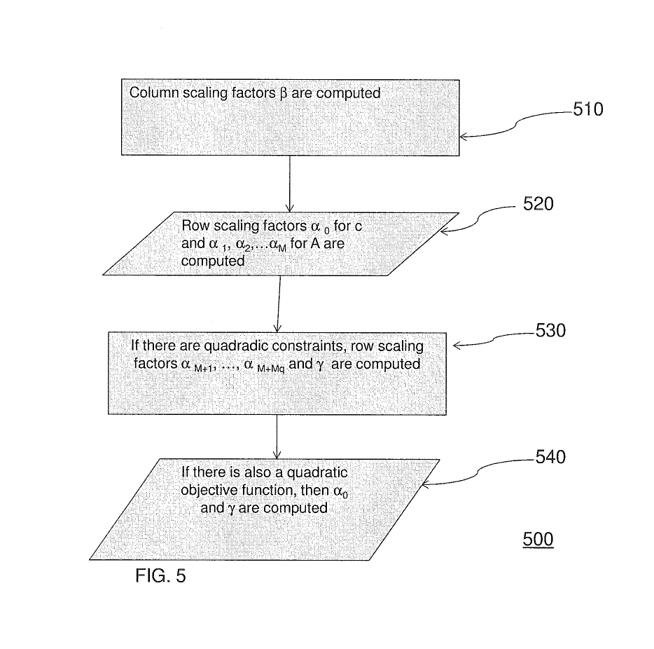

An example of a numerical scaling method is shown in the following. Referring to FIG. 5, the following numerical scaling method 500 is illustrated.

Choose an external “scaling function” ƒ(S) that can represent equilibration method, approximate geometric mean or arithmetic mean.

Step 510. The column scaling factors are computed by setting βⱼ=ƒ(S_{β}_{ⱼ}) with

S_{β}_{ⱼ}={Aᵢⱼ:i=1, . . . ,M}∪{dⱼ^{k}:k=1, . . . ,M_{q}}∪{\sqrt{Qⱼⱼ^{k}}:k=0, . . . ,M_{q}}.

Step 520. The row scaling factors for c and A are computed by setting α₀=ƒ(S_{α}_{₀}) with

S_{α}_{₀}={βⱼcⱼ:j=1, . . . ,N}

and, for i=1, . . . , M, set αᵢ=ƒ(S_{α}_{ᵢ}) with

S_{α}_{ᵢ}={βⱼAᵢⱼ:j=1, . . . ,N}.

Step 530. To find γ and α_{M+k} for k=1, . . . , M_{q}, compute ξ=ƒ(S_{ξ}) with

S_{ξ}={αᵢbᵢ:i=1, . . . ,M}

and, for k=1, . . . , M_{q}, compute ωₖ=ƒ(S_{ω}_{ₖ}) with

S_{ω}_{ₖ}={βⱼdⱼ^{k}:j=1, . . . ,N},

τₖ=ƒ(S_{τ}_{ₖ})/ƒ(S_{τ}_{ₖ}′) with

S_{τ}_{ₖ}={βⱼ\sqrt{Qⱼⱼ^{k}}:j=1, . . . ,N} and S_{τ}_{ₖ}′={αᵢβⱼAᵢⱼ:i=1, . . . ,M;j=1, . . . ,N},

and νₖ=ƒ(S_{ν}_{ₖ}) with S_{ν}_{ₖ}={h^{k}}.
Then set ψₖ=τₖ² and minimize

$$g ( γ , {α}_{M + 1} , … , {α}_{M + {M}_{q}} ) = {δ}_{ξ} \cdot {( log ( γ ) - log ( ξ ) )}^{2} + {\sum }_{k = 1}^{{M}_{q}} {δ}_{{ω}_{k}} \cdot {( log ( {α}_{M + k} ) - log ( {ω}_{k} ) )}^{2} + {\sum }_{k = 1}^{{M}_{q}} {δ}_{{ψ}_{k}} \cdot {( log ( {α}_{M + k} ) - log ( γ ) - log ( {ψ}_{k} ) )}^{2} + {\sum }_{k = 1}^{{M}_{q}} {δ}_{{v}_{k}} \cdot {( log ( {α}_{M + k} ) + log ( γ ) - log ( {v}_{k} ) )}^{2}$$

to compute α_{M+1}, . . . , α_{M+M}_{_{q}} and γ.

Step 540. If there is also a quadratic objective function

$${c}^{T} x + \frac{1}{2} {x}^{T} {Q}^{0} x ,$$

then for the resulting problem is essentially a QCP with M_{q}+1 quadratic constraints. However, there is no explicit α_{M+M}_{_{q}}+1 scaling factor in this case, rather, α₀ is effectively the row scaling factor for the M_{q}+1 quadratic constraint. Thus, instead of obtaining α₀ in the usual way, we set ω_{M}_{_{q}}₊₁=ƒ(S_{ωM}_{_{q+1}}) with

S_{ωM}_{_{q+1}}={βⱼcⱼ:j=1, . . . ,N},

τ_{M}_{_{q}}₊₁=ƒ(S_{τM}_{_{q+1}})/ƒ(S_{τM}_{_{q+1}}′) with

S_{τM}_{_{q+1}}={βⱼ\sqrt{Qⱼⱼ⁰}:j=1, . . . ,N} and S_{τM}_{_{q+1}}={αᵢβⱼAᵢⱼ:i=1, . . . ,M;j=1, . . . ,N},

and ν_{M}_{_{q}}₊₁=ƒ(S_{νM}_{_{q+1}}) with S_{νM}_{_{q+1}}={0} when computing γ and α_{M+1}, . . . , α_{M+M}_{_{q}}, α_{M+M}_{_{q}}₊₁. Then we set α₀=α_{M+M}_{_{q}}₊₁.

Given a quadratic program, the goal is to preprocess the quadratic program by applying numerical scaling factors to the coefficients of the constraints and objective function of the problem to make the problem easier to solve by a mathematical programming engine, such as IBM ILOG CPLEX. Current solutions for numerically scaling mathematical programs only use the input data corresponding to the linear part of the problem and do not work well when a quadratic objective or quadratic constraints are present. The exemplary embodiments of invention create numerical scaling techniques for problems that have quadratic objectives as well as quadratic constraints.

One can consider the Karush-Kuhn-Tucker equations that represent the optimality conditions for the quadratic program. Using these equations, scaling factors are derived and applied to the original problem formulation.

When financial portfolio optimization problems are solved on a computer 600, they are often formulated as mathematical programs with quadratic objectives and/or quadratic constraints. Often the units of different investment options differ by large magnitudes as shown above. The default numerical scaling methods do not work well when the problems have quadratic objectives and/or quadratic constraints, such that the underlying solver, such as IBM ILOG CPLEX, cannot provide accurate answers to the portfolio optimization problem. The proposed numerical scaling method has been demonstrated to improve the accuracy and quality of solutions provided by CPLEX for these problems.

The methods of the present application have been suggested as an enhancement to solver programs such as CPLEX. Testing indicates that performance of CPLEX on a large number of portfolio optimization problems is improved with the use of the proposed numerical scaling method.

Another benefit of the exemplary embodiments is improved solution times for the quadratic programming solver, as well as improved numerical accuracy of the solver.

The idea of using the optimality conditions for the quadratic program (the Karush-Kuhn-Tucker conditions) to determine the scaling factors has never been used with numerical scaling methods.

### Exemplary Hardware Implementation

FIG. 6 illustrates a typical hardware configuration of an information handling/computer system 600 in accordance with the invention and which preferably has at least one processor or central processing unit (CPU) 611. The computer system 600 can implement the numerical scaling algorithm for mathematical programs with quadratic objectives and/or quadratic constraints.

The CPUs 611 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting an information handling system to a data processing network, the Internet, an Intranet, a personal area network (PAN), etc., and a display adapter 636 for connecting the bus 612 to a display device 638 and/or printer 639 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing storage media tangibly embodying a program of machine-readable instructions executable by a digital data processor incorporating the CPU 611 and hardware above, to perform the method of the invention.

This signal-bearing storage media may include, for example, a RAM contained within the CPU 611, as represented by the fast-access storage for example.

Alternatively, the instructions may be contained in another signal-bearing storage media 700, such as a magnetic data storage diskette 701 or optical storage diskette 702 (FIG. 7), directly or indirectly accessible by the CPU 611. The storage media 700 can store the numerical scaling method for mathematical programs with quadratic objectives and/or quadratic constraints and can be executed by the CPU 611 of the computer system 600.

Whether contained in the diskette 701, 702, the computer/CPU 611, or elsewhere, the instructions may be stored on a variety of machine-readable data storage media or computer readable storage medium, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing storage media, including memory devices in transmission media, such as communication links and wireless devices, and in various formats, such as digital and analog formats. In an illustrative embodiment of the invention, the machine-readable instructions may comprise software object code.

Therefore, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Therefore, based on the foregoing exemplary embodiments of the invention, the numerical scaling method for mathematical programs with quadratic objectives and/or quadratic constraints can improve the accuracy of the computations and the overall stability of the implementation of the solving.

Although examples of the numerical scaling method are shown, alternate embodiments are also possible, including for example, numerical scaling methods for higher order problem solving and computation in computers or other machines that must compute high level mathematical problems.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for a quadratic program or quadratically constrained program stored in a non-transitory computer readable medium, the method comprising:
receiving input for coefficients of a quadratic problem or a quadratically constrained problem by a computer for storage in the non-transitory computer readable medium;
determining scaling factors by a processor by using the input in the quadratic program or quadratically constrained program configured for optimality conditions by considering symmetric N×N matrices Q⁰ and/or Q^{k} in the transformation, where N is an integer and k=1, . . . , M_{q} is an integer; and
outputting, by the computer, transformed coefficients of column scaling factor β, row scaling factor α, and right hand side scaling factor γ, where β>0, α>0 and γ>0.

2. The method according to claim 1, wherein:
the receiving further comprises receiving input for coefficients A, b, and Q⁰ by the computer for storage in the non-transitory computer readable medium;
the determining further comprises scaling factors by a processor in the computer by using the input in a quadratic program:
$${min}_{x} {c}^{T} x + 1 / 2 {x}^{T} {Q}^{0} x$$
$$s . t . \\ Ax = b$$
$$x \geq 0$$
where c is a cost vector of size N, b is a vector of right hand side variables of size M, and Q⁰ is a symmetric N×N matrix, A is an M×N matrix, where N and M are integers, x is a vector of N variables,
wherein a transformation for the scaling factors provides for the quadratic programs as follows:
$$min {\tilde{c}}^{T} \tilde{x} + \frac{1}{2} {\tilde{x}}^{T} {\tilde{Q}}^{0} \tilde{x}$$
$$s . t . \\ \tilde{A} \tilde{x} = \tilde{b} {\tilde{c}}_{j} = {α}_{0} {β}_{j} {c}_{j}$$
$$\tilde{x} \geq 0$$
$${\tilde{Q}}_{ij}^{0} = \frac{{α}_{0} {β}_{i} {β}_{j}}{γ} {Q}_{ij}^{0} {\tilde{A}}_{ij} = {α}_{i} {β}_{j} {A}_{ij} {\tilde{b}}_{i} = {α}_{i} γ {b}_{i} .$$

3. The method according to claim 2, wherein:
the receiving further comprises receiving input for coefficients d^{k}, h^{k}, and Q^{k} where d^{k} are M_{q} vectors of size N, h^{k} is a vector of size M_{q}, and Q^{k} are M_{q} matrices of size N×N, and M_{q} is an integer, by the computer for storage in the non-transitory computer readable medium;
the determining further comprises scaling factors by a processor in the computer by using the input in a quadratically constrained program:
$${min}_{x} {c}^{T} x + 1 / 2 {x}^{T} {Q}^{0} x$$
$$s . t . \\ {( {d}^{k} )}^{T} x + {x}^{T} {Q}^{k} \leq {h}^{k} , \\ k = 1 , … , {M}_{q}$$
$$Ax = b$$
$$x \geq 0 ,$$
wherein the transformation provides for quadratically constrained programs as follows:
$$min {\tilde{c}}^{T} \tilde{x} + \frac{1}{2} {\tilde{x}}^{T} {\tilde{Q}}^{0} \tilde{x}$$
$$s . t . \\ {( {\tilde{d}}^{k} )}^{T} \tilde{x} + {\tilde{x}}^{T} {\tilde{Q}}^{k} \tilde{x} \leq {\tilde{h}}^{k} , \\ k = 1 , … , {M}_{q}$$
$$\tilde{A} \tilde{x} = \tilde{b}$$
$$\tilde{x} \geq 0$$
$$\begin{matrix}{\tilde{d}}_{j}^{k} = {α}_{M + k} {β}_{j} {d}_{j}^{k} & {\tilde{Q}}_{ij}^{k} = \frac{{α}_{M + k} {β}_{i} {β}_{j}}{γ} {Q}_{ij}^{k} \\ {\tilde{h}}^{k} = {α}_{M + k} γ {h}^{k} & {\tilde{c}}_{j} = {α}_{0} {β}_{j} {c}_{j} .\end{matrix}$$

4. The method according to claim 3, wherein inputs of coefficients A, b, c, Q⁰, Q^{k}, d^{k}, h^{k} are received by the computer for storage on the non-transitory computer readable medium for the quadratically constrained programs, the inputs of coefficients being real numbers.

5. The method according to claim 1, further comprising sending the outputs to a solver program for mathematical computation in the computer,
wherein the optimality conditions comprise Karush-Kuhn-Tucker conditions for quadratic programming.

6. The method according to claim 1, wherein the determining of scaling factors further comprises determining column scaling factors β by using a scaling function.

7. The method according to claim 6, wherein the determining of scaling factors further comprises after determining the column scaling factor, determining row scaling factors α by using the scaling function.

8. The method according to claim 7, wherein the determining of scaling factors further comprises determining the right hand side scaling factor γ.

9. The method according to claim 8, wherein the determining of scaling factors further includes:
when there is a quadratic objective function
setting an initial row scaling factor of α₀ for a quadratic constraint when a quadratic objective function is identified.

10. A method for a quadratic program or quadratically constrained program, the method comprising:
receiving input for coefficients of a quadratic problem or a quadratically constrained problem by a computer for storage in the non-transitory computer readable medium; and
determining scaling factors by a processor by using the input in the quadratic program or quadratically constrained program configured for optimality conditions by considering a symmetric N×N matrix Q⁰ and/or M_{q} N×N matrices Q^{k} in the transformation, where N is an integer and k=1, . . . , M_{q} is an integer,
wherein the scaling factors comprise transformed coefficients of column scaling factor β, row scaling factor α, and right hand side scaling factor γ, where β>0, α>0 and γ>0.

11. The method according to claim 10, wherein:
the receiving further comprises receiving input for coefficients A, b, and Q⁰ by the computer for storage in the non-transitory computer readable medium;
the determining further comprises scaling factors by a processor in the computer by using the input in a quadratic program:
$${min}_{x} {c}^{T} x + 1 / 2 {x}^{T} {Q}^{0} x$$
$$s . t . \\ Ax = b$$
$$x \geq 0$$
where c is a cost vector of size N, b is a vector of right hand side variables of size M, and Q⁰ is a symmetric N×N matrix, A is an M×N matrix, where N and M are integers, x is a vector of N variables,
wherein a transformation for the scaling factors provides for the quadratic programs as follows:
$$min {\tilde{c}}^{T} \tilde{x} + \frac{1}{2} {\tilde{x}}^{T} {\tilde{Q}}^{0} \tilde{x}$$
$$s . t . \\ \tilde{A} \tilde{x} = \tilde{b} {\tilde{c}}_{j} = {α}_{0} {β}_{j} {c}_{j}$$
$$\tilde{x} \geq 0$$
$${\tilde{Q}}_{ij}^{0} = \frac{{α}_{0} {β}_{i} {β}_{j}}{γ} {Q}_{ij}^{0} {\tilde{A}}_{ij} = {α}_{i} {β}_{j} {A}_{ij} {\tilde{b}}_{i} = {α}_{i} γ {b}_{i} .$$

12. The method according to claim 11, wherein:
the receiving further comprises receiving input for coefficients d^{k}, h^{k}, and Q^{k} by the computer for storage in the non-transitory computer readable medium;
the determining further comprises scaling factors by a processor in the computer by using the input in a quadratically constrained program:
$$min {\tilde{c}}^{T} \tilde{x} + \frac{1}{2} {\tilde{x}}^{T} {\tilde{Q}}^{0} \tilde{x}$$
$$s . t . \\ {( {d}^{k} )}^{T} x + {x}^{T} {Q}^{k} \tilde{x} \leq {h}^{k} , \\ k = 1 , … , {M}_{q}$$
$$Ax = \tilde{b}$$
$$x \geq 0$$
wherein the transformation provides for quadratically constrained programs as follows:
$$min {\tilde{c}}^{T} \tilde{x} + \frac{1}{2} {\tilde{x}}^{T} {\tilde{Q}}^{0} \tilde{x}$$
$$s . t . \\ {( {\tilde{d}}^{k} )}^{T} \tilde{x} + {\tilde{x}}^{T} {\tilde{Q}}^{k} \tilde{x} \leq {\tilde{h}}^{k} , \\ k = 1 , … , {M}_{q}$$
$$\tilde{A} \tilde{x} = \tilde{b}$$
$$\tilde{x} \geq 0$$
$$\begin{matrix}{\tilde{d}}_{j}^{k} = {α}_{M + k} {β}_{j} {d}_{j}^{k} & {\tilde{Q}}_{ij}^{k} = \frac{{α}_{M + k} {β}_{i} {β}_{j}}{γ} {Q}_{ij}^{k} \\ {\tilde{h}}^{k} = {α}_{M + k} γ {h}^{k} & {\tilde{c}}_{j} = {α}_{0} {β}_{j} {c}_{j} .\end{matrix}$$

13. The method according to claim 12, wherein inputs of coefficients A, b, c, Q⁰, Q^{k}, d^{k}, h^{k} are received by the computer for storage on the non-transitory computer readable medium for the quadratically constrained programs.

14. The method according to claim 10, wherein the optimality conditions comprise Karush-Kuhn-Tucker conditions for quadratic programming.

15. The method according to claim 10, further comprising sending the scaling factors to a solver program for mathematical computation in the computer.

16. The method according to claim 10, wherein the determining of scaling factors further comprises determining column scaling factors β by using a scaling function.

17. The method according to claim 16, wherein the determining of scaling factors further comprises after determining the column scaling factor, determining row scaling factors α by using the scaling function.

18. The method according to claim 17, wherein the determining of scaling factors further comprises determining the right hand side scaling factor γ.

19. The method according to claim 18, wherein the determining of scaling factors further comprises:
when there is a quadratic objective function, setting an initial row scaling factor of α₀ for a quadratic constraint when a quadratic objective function is identified.

20. A computer for a quadratic program and quadratically constrained program, the computer comprises:
a non-transitory computer readable memory storing input for coefficients of the quadratic problem or the quadratically constrained problem;
a processor determining scaling factors by using the input in the quadratic program or the quadratically constrained program configured for optimality conditions by considering a symmetric N×N matrix Q⁰ and/or M_{q} N×N matrices Q^{k} in the transformation, where N is an integer and k=1, . . . , M_{q} is an integer; and
an output section outputting transformed coefficients of column scaling factor β, row scaling factor α, and right hand side scaling factor γ, where β>0, α>0 and γ>0.
